(19) United States
(12) Patent Application Publication
(10) Pub. No.: US 2026/0289533 A1
(43) Pub. Date: Sep. 24, 2026

(54) Distribution Model for Subscription-Based Access to Short Films for Libraries, Other Venues, and Related Methods

(71) Applicant: Christine Boulware, Dallas, TX (US)

(72) Inventor: Christine Boulware, Dallas, TX (US)

(21) Appl. No.: 19/086,404

(22) Filed: Mar. 21, 2025

(51) Int. Cl. G06Q 20/10; G06Q 30/04; G06Q 50/26

(52) U.S. Cl. CPC G06Q 20/102; G06Q 30/04; G06Q 50/26

(57) ABSTRACT

This document describes a computer-implemented method and system for providing access to curated short films through a subscription-based distribution model for libraries and other venues. The model incentivizes film festival partners by sharing a portion of subscription revenue, encouraging them to promote the service. Library patrons can access these films using a library card, with potential monthly viewing limits. The system is designed to operate across various venues and cities worldwide, enhancing content availability and promotion through partnerships with film festival partners.

### TECHNICAL FIELD

The present disclosure relates to a distribution model for subscription-based access to short films, and more particularly, to a method for libraries and other venues to provide access to short films in partnership with film festivals worldwide,

### BACKGROUND

Libraries have long served as vital community resources, offering access to a wide range of educational and entertainment materials. In recent years, there has been a growing interest in expanding the digital offerings of libraries to include more diverse and contemporary content, such as films and multimedia. This shift is driven by the increasing demand for digital content and the need to attract a broader audience, including younger generations who are more inclined towards digital media consumption.

Film festivals, for their part, are platforms that celebrate the art of filmmaking and provide filmmakers with opportunities to showcase their work to a wider audience. However, many short films showcased at these festivals often struggle to find distribution channels beyond the festival circuit, limiting their reach and impact. There is a need for innovative distribution models that can bridge the gap between filmmakers and audiences, providing filmmakers with more exposure and audiences with access to diverse film content. This need is particularly pronounced in libraries, which are seeking ways to enhance their digital collections and engage their communities with unique and culturally enriching content,

### SUMMARY

A computer-based approach will involve offering access to specially selected short films to libraries and other venues through a subscription model. The subscription model can share some of the revenue with film festival partners, encouraging them to promote the model. Library patrons will access these films using a library card. The subscription model will provide access to the curated short films for libraries located in various cities worldwide.

The embodiment allows users to collaborate with film festival partners to promote the subscription model and motivate filmmakers to contribute, which will lead to more content and promotion. Library patrons will have monthly limits on how many curated short films they can view. In a non-limiting example, the system is designed to offer access to curated short films, including a subscription model that provides access to libraries and shares some revenue with film festival partners. Additionally, platform users can work with film festival partners to promote the subscription model and encourage filmmaker contributions, potentially increasing content and promotion, A computer-readable medium will store instructions that, when executed, enable a processor to provide access to curated short films for libraries through a subscription model. It will be appreciated by users that the current embodiment can be utilized in various types of venues throughout the world and not just domestically.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of what has been invented by the inventor,

### BRIEF DESCRIPTION OF THE DRAWINGS

FIG. 1 illustrates a subscription model for library access to curated short films, in accordance with at least one embodiment.

FIG. 2 illustrates a subscription-based film distribution system for libraries, in accordance with at least one embodiment.

### DETAILED DESCRIPTION

The terms “a” or “an”, as used herein, are defined as one, or more than one, The term “plurality”, as used herein, is defined as two, or more than two. The term “another”, as used herein, is defined as at least a second or more, The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an exemplary embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment.

Furthermore, the particular features, structures, or characteristics may be combined in any suitable manner in one or more embodiments without limitation. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments will be utilized. It should be appreciated, however, that such features are not limited to usage in the one or more particular embodiments with reference to which they are described. The present disclosure is neither a literal description of all embodiments of one or more of the inventions nor a listing of features of one or more of the inventions that must be present in all embodiments.

Alternate implementations are included within the scope of embodiments of the present invention that would be understood by those having ordinary skill in the art.

Headings of sections provided in this patent application and the title of this patent application are for convenience only and are not to be taken as limiting the disclosure in any way.

The disclosure provides a system and method for offering subscription-based access to curated short films for libraries and other venues. The system will include a subscription-based distribution model that can provide access to short films and share a portion of subscription revenue with film festival partners. This sharing of revenue may incentivize film festival partners to promote the distribution model. In a non-limiting example, library patrons will access the curated short films using a library card, which will have monthly viewing limits. As previously discussed, the system will also allow platform users to partner with film festival partners to promote the distribution model and encourage filmmaker contributions, resulting in increased content and promotion. The system aims to enhance the availability and promotion of short films through libraries across various cities worldwide.

Access to curated short films will be provided to library patrons through a subscription-based distribution model. The distribution model will be designed to offer subscription-based access to short films, potentially allowing libraries to provide this service to their patrons. It will further be appreciated that the subscription-based model will be structured to share a portion of the subscription revenue with film festival partners. This revenue-sharing arrangement is instrumental with incentivizing the film festival partners to promote the distribution model, thereby potentially increasing the visibility and reach of the short films. This collaborative approach will enhance the content available to library patrons, providing them with a diverse selection of short films to access through their library cards, The system keeps track of subscription revenue from libraries, calculating and distributing revenue shares to partner film festivals based on agreed terms.

According to an embodiment, a method will be provided for end-users to partner with local film festivals. The sharing of subscription fees will also incentivize the film festivals to host a dedicated page on a website. This dedicated page may serve as a promotional tool for the platform. The platform may also encourage filmmakers to contribute content, thereby increasing the variety and volume of short films available. The website will involve a dedicated hosted page, allowing for broader visibility and engagement. The local film festivals will play a role in promoting the platform to their network, potentially expanding the reach and impact of the distribution model. The users, who will be individuals or groups interested in supporting the arts, will find value in this collaborative approach. The content contributed by filmmakers will enhance the platform's offerings, providing a richer experience for patrons. This model will create a symbiotic relationship between the platform, the film festivals, and the filmmakers, fostering a sustainable ecosystem for short film distribution. In a non-limiting example, the library onboarding process includes identifying target libraries in the top 150 cities, and displaying the subscription offering, highlighting the value to patrons and alignment with the libraries' missions. The patrons will have the option of signing the subscription agreements and integrate the platform with a library card authentication system.

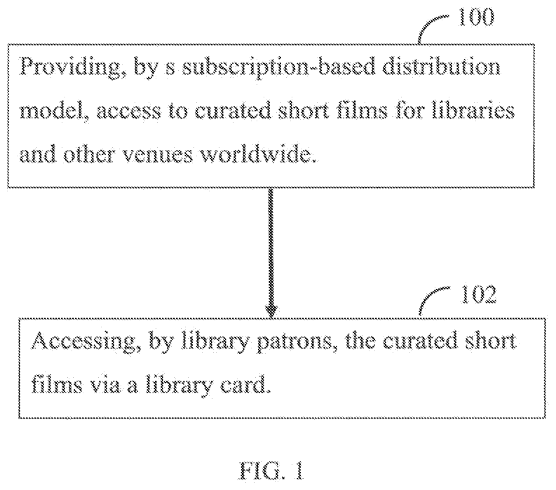

Turning now to FIG. 1 is a flowchart illustrating a method in step 100 for providing access to curated short films for libraries and other venues via a subscription-based distribution model, according to an embodiment. At step 100, the distribution model will be configured to provide access to short films specifically curated for libraries. This access will be facilitated through a subscription-based model, which can potentially enhance the availability of diverse film content to library patrons. This sharing of revenue will serve as an incentive for film festival partners to actively promote the distribution model, thereby potentially increasing its reach and effectiveness. The model will allow for the establishment of partnerships between platform users and film festival partners, which can encourage filmmaker contributions and result in increased content and promotion. The distribution model will also be structured to provide access to the curated short films for libraries across various cities worldwide. This widespread access can potentially enhance the cultural and educational resources available to library patrons, Additionally, the model will incorporate a process for library patrons to access the curated short films with monthly viewing limits, which can help manage the consumption of content and ensure equitable access for all patrons.

In the context of the described system, step 102 will involve the process where library patrons can access curated short films through the use of a library card. This step will be part of a broader subscription-based distribution model that aims to provide access to these films for libraries. The library card will serve as a means for patrons to authenticate and gain access to the film content. The curated short films will be made available to patrons, potentially enhancing their viewing experience by offering a selection of films that have been specifically chosen for quality or relevance. The subscription-based distribution model will extend its reach across various cities worldwide, thereby allowing a wide range of libraries and other venues to participate in this offering. Additionally, platform users will engage in partnerships with film festival partners to promote the distribution model and encourage contributions from filmmakers, which will result in an increase in available content and promotional activities. Furthermore, the library patrons' access to the curated short films will be subject to monthly viewing limits, which could be a measure to manage the consumption of content and ensure fair usage among all patrons. This structured approach will facilitate a sustainable model for distributing short films to libraries while fostering collaboration with film festivals and filmmakers,

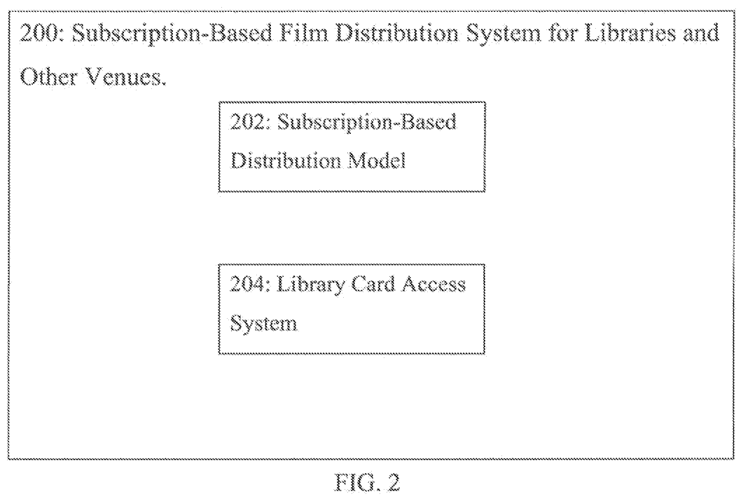

Turning now to FIG. 2 illustrates the subscription-based distribution model, which will serve as the primary process for distributing curated short films to libraries. This model will provide subscription-based access to short films, potentially enhancing the availability of curated content for library patrons. The distribution model will be designed to integrate with libraries, allowing for a seamless provision of short films. The curated short films will be accessed by library patrons, who will utilize their library cards to gain entry to the content. The model will also incorporate a revenue-sharing component, where a portion of the subscription fees will be shared with film festival partners. This sharing mechanism will incentivize film festival partners to promote the distribution model, potentially increasing the reach and impact of the platform. The integration of film festival partners will be facilitated through a dedicated page on a website, which will serve as a promotional tool for the platform. The model will also encourage filmmakers to contribute content, thereby enriching the library's offerings. The subscription-based distribution model will be configured to operate effectively and potentially expanding the accessibility of short films to a broader audience. The model will also impose monthly viewing limits for library patrons, ensuring a controlled and manageable access to the curated content. Through this process, the subscription-based distribution model will effectively distribute short films to libraries, providing a valuable resource for library patrons.

The library card access system, identified as component 204, will facilitate the access of curated short films by library patrons through the utilization of their library cards. This system will be designed to enable library patrons to engage with the curated content, thereby providing a seamless interface for accessing films. The library card, as a pivotal element of this system, will serve as the authentication tool that allows patrons to access the curated short films. The system will be configured to impose monthly viewing limits, ensuring that access is regulated and managed effectively.

The library card access system will operate in conjunction with the subscription-based distribution model, which is responsible for the provision of curated short films to libraries. This integration will ensure that library patrons can access a diverse range of films, thereby enhancing the overall user experience. The system will also be designed to work in harmony with the film festival partner integration, which will promote and enhance the content available through the system.

The functions associated with the library card access system will include offering library patrons access to short films through their library card and providing subscription-based access to short films. These functions will be aimed at providing access with monthly viewing limits and offering access to short films for libraries and other venues. The system will be configured to allow users to share a portion of subscription fees with partner film festivals, thereby promoting the platform and encouraging filmmakers to contribute content.

In summary, the library card access system, component 204, will play a role in facilitating access to curated short films for library patrons, ensuring that the system operates efficiently and effectively within the broader framework of the subscription-based distribution model.

While the present invention has been described above in terms of specific embodiments for purposes of illustration, it is to be understood that the invention is not limited to these disclosed embodiments. Likewise, while “the invention” or “present invention” may have been referred to at times in this disclosure those terms are not intended to limit the scope of this disclosure or to suggest in any way that there is a single version or embodiment. Various modifications and changes can be made without departing from the spirit of the invention. In fact, modifications and other embodiments of the invention will also come to mind of those skilled in the art to which this invention pertains, and which are intended to be and are covered by both this disclosure and the appended claims. It is indeed intended that the scope should be determined by proper interpretation and construction of the appended claims and their legal equivalents, as understood by those skilled in the art relying upon the disclosure in this specification and the attached drawings.

The skilled person will be aware of a range of possible modifications of the various embodiments described above. Accordingly, the present invention is defined by the claims and their equivalents.

What is claimed is:

1. A computer-implemented method, comprising:
providing, by a subscription-based distribution model, access to curated short films for libraries and other venues, wherein the subscription-based distribution model shares a portion of subscription revenue with film festival partners to incentivize the film festival partners to promote the subscription-based distribution model; and
accessing, by library patrons, the curated short films via a library card.

2. The computer-implemented method of claim 1, wherein the subscription-based distribution model provides access to the curated short films for libraries and other venues across various cities worldwide.

3. The computer-implemented method of claim 1, further comprising:
partnering, by platform users, with the film festival partners to promote the subscription-based distribution model and encourage filmmaker contributions, resulting in increased content and promotion.

4. The computer-implemented method of claim 1, wherein the library patrons access the curated short films with monthly viewing limits,

5. A system for providing access to curated short films, the system comprising:
a subscription-based distribution model configured to:
provide access to the curated short films for libraries and other venues; and
share a portion of subscription revenue with film festival partners to incentivize the film festival partners to promote the subscription-based distribution model; and
a library card associated with library patrons, wherein the library card enables the library patrons to access the curated short films.

6. The system of claim 5, wherein the subscription-based distribution model provides access to the curated short films for libraries across various cities worldwide.

7. The system of claim 5, further comprising:
platform users configured to partner with the film festival partners to promote the subscription-based distribution model and encourage filmmaker contributions, resulting in increased content and promotion.

8. The system of claim 5, wherein the library card enables the library patrons to access the curated short films with monthly viewing limits.

9. A non-transitory computer-readable medium storing instructions that, when executed by a processor, cause the processor to perform operations comprising:
providing, by a subscription-based distribution model, access to curated short films for libraries and other venues, wherein the subscription-based distribution model shares a portion of subscription revenue with film festival partners to incentivize the film festival partners to promote the subscription-based distribution model; and
enabling library patrons to access the curated short films via a library card.

10. The non-transitory computer-readable medium of claim 9, wherein the subscription-based distribution model provides access to the curated short films for libraries across various cities.

11. The non-transitory computer-readable medium of claim 9, the operations further comprising:
partnering, by platform users, with the film festival partners to promote the subscription-based distribution model and encourage filmmaker contributions, resulting in increased content and promotion.

12. The non-transitory computer-readable medium of claim 9, wherein the library card enables the library patrons to access the curated short films with monthly viewing limits.
